(19) United States
(12) Patent Application Publication
(10) Pub. No.: US 2026/0233801 A1
(43) Pub. Date: Aug. 13, 2026

(54) BICYCLE STEM AND BICYCLE PROVIDED WITH BICYCLE STEM

(71) Applicant: YAMAHA HATSUDOKI KABUSHIKI KAISHA, Iwata-shi (JP)

(72) Inventors: Tomoyuki HIGASHI, Shizuoka (JP); Mitsuharu HASUMI, Shizuoka (JP); Nobuo HARA, Shizuoka (JP); Shiro NAKADA, Kyoto-shi (JP)

(21) Appl. No.: 19/639,353

(22) Filed: Apr. 6, 2026

Related U.S. Application Data
(63) Continuation-in-part of application No. PCT/JP2024/035778, filed on Oct. 7, 2024.

(30) Foreign Application Priority Data
Oct. 6, 2023 (WO) PCT/JP2023/036641

(51) Int. Cl. B62K 21/12; B62J 45/411; B62J 45/422

(52) U.S. Cl. CPC B62K 21/12; B62J 45/411; B62J 45/422

(57) ABSTRACT

A torque sensor of a bicycle stem is more deformable by a torque about an X axis than by a torque about a Y axis or a torque about a Z axis when an identical torque is applied respectively about the X, Y, and Z axes, which are mutually orthogonal. The bicycle stem includes a first stem including a handlebar connector connected to a handlebar and a first torque sensor connector connected to the torque sensor, and a second stem including a steering column connector connected to a steering column and a second torque sensor connector connected to the torque sensor. The first and second stems are configured such that the handlebar connector is positioned farther forward than the steering column and such that, when an identical torque about the X axis is applied, the first and second stems are less deformable than the torque sensor.

### CROSS REFERENCE TO RELATED APPLICATIONS

This application claims the benefit of priority to PCT Application No. PCT/JP 2023/036641 filed on Oct. 6, 2023 and is a Continuation-in-Part Application of PCT Application No. PCT/JP 2024/035778 filed on Oct. 7, 2024. The entire contents of each application are hereby incorporated herein by reference.

### BACKGROUND OF THE INVENTION

### 1. Field of the Invention

The present invention relates to bicycle stems and bicycles including the bicycle stems.

### 2. Description of the Related Art

As a component for connecting a steering column and a handlebar of a bicycle, a bicycle stem is known. Generally, the bicycle stem includes an ahead stem and a quill stem. The ahead stem is directly connected to an upper portion of the steering column. The quill stem is connected to the steering column by pressing a fixing member provided at its lower end portion against an inner surface of the upper portion of the steering column.

In recent years, configurations have been known in which a steering assist device is provided on a bicycle to assist steering of the bicycle. As such a configuration, for example, Chinese Patent Application Publication No. 103112540 discloses an electric power steering control system that provides an electric power steering function by controlling an assist motor and a magnetic clutch in response to signals from a torque sensor that detects a torque of an input shaft and from a vehicle speed sensor that detects vehicle speed.

U.S. Patent Application Publication No. 2020/0102043, for example, discloses a robotic steering mechanism for an autonomous bicycle, which includes a sensor, a steering control assembly configured to adjust a steering angle of a front wheel of the bicycle, and a controller that acquires values from the sensor. The controller adjusts the steering angle by the steering control assembly based on the values from the sensor.

U.S. Patent Application Publication No. 2020/0102043 discloses that a torque sensor is provided between a stem of a handlebar and a steering tube of a bicycle frame.

For example, U.S. Patent Application Publication No. 2021/0396614 discloses a bicycle power meter including at least one strain gauge disposed on an outer peripheral wall of a stem, on an inner peripheral wall of the stem, or on both of the outer and inner peripheral walls of the stem, as well as a signal processing unit, a processor, and a signal transmitter.

### SUMMARY OF THE INVENTION

As disclosed in Chinese Patent Application Publication No. 103112540 and U.S. Patent Application Publication No. 2020/0102043 described above, configurations including a torque sensor for assisting handlebar operation of a bicycle are known. However, none of the documents disclose specific configurations related to the torque sensor, such as the arrangement or mounting structure of the torque sensor.

In assisting handlebar operation of a bicycle as described above, it is preferable that the torque sensor has directionality so that a torque in a rotational direction of a steering column can be accurately detected.

In contrast, U.S. Patent Application Publication No. 2021/0396614 discloses a strain gauge disposed on an outer peripheral wall of a stem, on an inner peripheral wall of the stem, or on both of the outer and inner peripheral walls of the stem. Although U.S. Patent Application Publication No. 2021/0396614 discloses that the strain gauge can measure deformation (strain) generated in the stem, it fails to disclose any example embodiment of the present invention of measuring deformation of the stem in a manner having directionality.

Accordingly, there is a demand for a bicycle stem in which a torque sensor is compactly provided so as to have directionality in a measuring direction by utilizing the shape and functions of the stem.

Example embodiments of the present invention provide bicycle stems in each of which a torque sensor is compactly provided so as to have directionality in a measuring direction by utilizing shapes and functions of the stems.

The present inventors have studied providing a torque sensor in a bicycle stem so as to have directionality in a measuring direction by utilizing the shapes and functions of the bicycle stems.

First, the inventors focused on the fact that a bicycle stem is a component connecting a steering column and a handlebar. That is, the bicycle stem includes a steering column connector that is connected to the steering column, and a handlebar connector that is connected to the handlebar. In the bicycle stem, as the steering column is viewed in its axial direction, the steering column connector and the handlebar connector of the bicycle stem are spaced apart from each other in a radial direction of the steering column.

Further, the inventors focused on the fact that the bicycle stem has higher rigidity than the handlebar. Specifically, the inventors initially considered that, by attaching a strain gauge to the handlebar whose rigidity is lower than that of the bicycle stem, a torque generated in the handlebar could be readily detected. However, the torque detected by the strain gauge attached to the handlebar also includes a torque other than the torque in a steering direction of the handlebar. Therefore, accurate detection of a steering torque may be difficult.

Next, the present inventors considered attaching a strain gauge to the bicycle stem and detecting a steering torque by the strain gauge. In such a case, it is necessary for the strain gauge to accurately detect minute deformation of the bicycle stem. However, it is difficult for the strain gauge to accurately detect minute deformation of the bicycle stem.

In consideration of the above points, the present inventors conceived of dividing the bicycle stem into a first stem and a second stem and disposing a torque sensor between the first and second stems, thus utilizing the high rigidity of the bicycle stem to accurately detect only a steering torque by the torque sensor. That is, the present inventors conceived of a bicycle stem configuration that, by disposing the torque sensor between the two stems, has a direction in which the first stem and the second stem are relatively displaced by a steering torque to facilitate detection of the steering torque by the torque sensor, and another direction in which deformation due to a torque other than the steering torque is suppressed by the high rigidity of the bicycle stem.

Specifically, the present inventors conceived of a configuration in which a torque sensor is disposed in the bicycle stem as described below. That is, the present inventors conceived of a configuration in which the stem includes a first stem including a handlebar connector connected to a handlebar and a first torque sensor connector connected to the torque sensor, and a second stem including a steering column connector connected to a steering column and a second torque sensor connector connected to the torque sensor. Moreover, the present inventors also conceived that the first stem and the second stem are configured such that the handlebar connector is positioned farther forward than the steering column and such that, when an identical torque about an X axis is applied, the first stem and the second stem are less deformable than the torque sensor.

As a result of intensive studies as described above, the present inventors conceived of and developed example embodiments of the present invention described below.

A bicycle stem according to one example embodiment of the present invention is a bicycle stem including a torque sensor. The torque sensor is more deformable by a torque about an X axis than by a torque about a Y axis or a torque about a Z axis when an identical torque is applied respectively about the X, Y, and Z axes, which are mutually orthogonal, to detect the torque about the X axis when a force is input from a handlebar or a steering column. The bicycle stem includes a first stem including a handlebar connector connected to the handlebar and a first torque sensor connector connected to the torque sensor, and a second stem including a steering column connector connected to the steering column and a second torque sensor connector connected to the torque sensor. The first stem and the second stem are configured such that the handlebar connector is positioned farther forward than the steering column and such that, when an identical torque about the X axis is applied, the first stem and the second stem are less deformable than the torque sensor.

The bicycle stem connects the handlebar and the steering column so as to transmit a torque. In the bicycle stem, as the steering column is viewed in an axial direction, the steering column connector and the handlebar connector are spaced apart from each other in a radial direction of the steering column.

Such a structure, serving as the bicycle stem, is separated into two stems including the first stem and the second stem as described above, and the torque sensor is provided between the first stem and the second stem. Accordingly, when an identical torque about the X axis is applied to the first stem and the second stem that are respectively connected to the torque sensor, the torque sensor is more deformable than the first stem and the second stem. Therefore, a signal-to-noise ratio (S/N ratio) of a torque signal detected by the torque sensor can be increased. As a result, torque detection accuracy of the torque sensor can be improved.

Moreover, the torque sensor is connected to each of the first stem and the second stem and is a part of the bicycle stem. Accordingly, the torque sensor is positioned relative to the first stem connected to the handlebar and the second stem connected to the steering column. With this configuration, as compared with a configuration in which a plurality of sensors are provided, variation in the mounting position of the sensor is reduced. As a result, torque detection accuracy can be improved.

Therefore, it is possible to realize a bicycle stem capable of improving torque detection accuracy of the torque sensor while utilizing the functions of the stem.

In another example embodiment of the present invention, the bicycle stem according to the present invention may have the following configuration. The X axis extends in a left-right direction, an up-down direction, or a front-rear direction.

By disposing the torque sensor with respect to the stem in accordance with a use condition of the bicycle, torque detection by the torque sensor can be performed in consideration of the use condition. Accordingly, an S/N ratio of a torque signal detected by the torque sensor can be increased, thus increasing torque detection accuracy of the torque sensor.

In another example embodiment of the present invention, the bicycle stem according to the present invention may have the following configuration. The first stem is spaced apart from the second stem in an X axis direction.

Thus, relative displacement between the first stem and the second stem more readily occurs due to a torque applied about the X axis. Therefore, the torque applied to the first stem and the second stem can be more readily detected by the torque sensor.

In another example embodiment of the present invention, the bicycle stem may further include an X axis direction movement restrictor positioned between the first stem and the second stem to restrict relative movement between the first stem and the second stem in an X axis direction by an amount that is equal to or greater than a predetermined amount.

Accordingly, it is possible to prevent reduction of performance or measurement accuracy of the torque sensor connected to each of the first stem and the second stem due to relative movement between the first stem and the second stem in the X axis direction by an amount that is equal to or greater than the predetermined amount.

In another example embodiment of the present invention, the bicycle stem further includes an X axis rotation restrictor positioned between the first stem and the second stem to restrict relative rotation between the first stem and the second stem about the X axis by an angle that is equal to or greater than a predetermined angle.

Accordingly, it is possible to prevent reduction of performance or measurement accuracy of the torque sensor connected to each of the first stem and the second stem due to relative rotation between the first stem and the second stem about the X axis by an angle that is equal to or greater than the predetermined angle.

In another example embodiment of the present invention, the first stem and the second stem are configured such that, as viewed in an axial direction of the steering column, the handlebar connector, the first torque sensor connector, the second torque sensor connector, and the steering column connector are arranged in a front-rear direction.

In such a configuration, the torque sensor is provided between the first torque sensor connector of the first stem and the second torque sensor connector of the second stem. The handlebar connector of the first stem and the steering column connector of the second stem are positioned radially outward with respect to the steering column as viewed in the axial direction of the steering column. With the torque sensor disposed relative to the first stem and the second stem in this manner, a torque applied to the handlebar or the steering column can be detected.

With the above-described configuration, as viewed in the axial direction of the steering column, the steering column connector, the first torque sensor connector, the handlebar connector, and the second torque sensor connector are arranged in the front-rear direction. Thus, the torque sensor can be compactly disposed in the left-right direction with respect to the bicycle stem.

Therefore, the torque sensor can be compactly disposed on the bicycle stem by utilizing the configuration and functions of the bicycle stem.

In another example embodiment of the present invention, the first torque sensor connector of the first stem or the second torque sensor connector of the second stem is connected to a housing of the torque sensor.

Accordingly, a torque applied to the first stem or the second stem can be accurately detected by the torque sensor by connecting the first stem or the second stem to the torque sensor.

In another example embodiment of the present invention, the first torque sensor connector of the first stem or the second torque sensor connector of the second stem is integral with at least a portion of a housing of the torque sensor.

Accordingly, a torque applied to the first stem or the second stem can be accurately detected by the torque sensor by connecting the first stem or the second stem to the torque sensor.

A bicycle according to an example embodiment of the present invention includes the bicycle stem having any one of the above-described configurations. In the bicycle, the torque sensor can be compactly disposed on the bicycle stem by utilizing the shape and functions of the bicycle stem.

The terminology used herein is for the purpose of describing particular example embodiments only and is not intended to be limiting.

As used herein, the term “and/or” includes any and all combinations of one or more of the associated listed items.

It will be further understood that the terms “including,” “comprising” or “having” and variations thereof when used in this specification, specify the presence of stated features, steps, operations, elements, components, and/or their equivalents but do not preclude the presence or addition of one or more steps, operations, elements, components, and/or groups thereof.

It will be further understood that the terms “mounted,” “connected,” “coupled,” and/or their equivalents are used broadly and encompass both direct and indirect mounting, connecting and coupling. Further, “connected” and “coupled” are not restricted to physical or mechanical connections or couplings, and can include electrical connections or couplings, whether direct or indirect.

Unless otherwise defined, all terms (including technical and scientific terms) used herein have the same meaning as commonly understood by one having ordinary skill in the art to which this teaching belongs.

It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing example embodiments of the present invention, it will be understood that a number of techniques and steps are disclosed. Each of these has individual benefits and each can also be used in conjunction with one or more, or in some cases all, of the other disclosed techniques.

Accordingly, for the sake of clarity, this description will refrain from repeating every possible combination of the individual steps in an unnecessary fashion. Nevertheless, the specification and claims should be read with the understanding that such combinations are entirely within the scope of the teaching.

Example embodiments of bicycle stems according to the present invention will be herein described.

In the following description, numerous specific details are set forth in order to provide a thorough understanding of example embodiments of the present invention. It will be evident, however, to one skilled in the art that example embodiments of the present invention may be practiced without these specific details.

The present disclosure is to be considered as merely an exemplification of example embodiments of the present invention, and is not intended to limit the present invention to the specific example embodiments illustrated by the figures or description below.

A bicycle stem herein refers to a component that connects a handlebar of a bicycle and a steering column that extends through a head tube. The bicycle stem includes an ahead stem that is directly connected to an upper portion of the steering column and a quill stem that is connected to the steering column by pressing a fixture provided at a lower end portion of the stem against an inner surface of the upper portion of the steering column. The bicycle may be a two wheeled vehicle or a three wheeled vehicle as long as the bicycle is a vehicle that obtains a driving force by a rider rotating pedals. The bicycle may be a vehicle configured to lean leftward or rightward, or may be a non-leaning vehicle with respect to the left-right direction.

A steering column herein refers to a component that is rotatably housed in a head tube and is connected to a fork portion that rotatably supports a front wheel, in a bicycle. A steering column connector of the bicycle stem is connected to the steering column.

A handlebar herein refers to a bar handle extending in a left direction and a right direction. A handlebar connector of the bicycle stem is connected to a center portion of the handlebar in the left-right direction.

“About an X axis” herein refers to a rotational direction about the X axis. “About a Y axis” refers to a rotational direction about the Y axis. “About a Z axis” refers to a rotational direction about the Z axis. The X axis, the Y axis, and the Z axis extend in directions orthogonal to each other. The X axis is, for example, an axis parallel to the axis of the steering column.

An X axis direction herein refers to a direction in which the X axis extends. A Y axis direction refers to a direction in which the Y axis extends. A Z axis direction refers to a direction in which the Z axis extends.

“Arranged in a straight line” herein refers to a state in which a handlebar connector, a torque sensor, and a steering column connector are arranged in a straight line within a predetermined range as viewed in an axial direction of the steering column. That is, in the straight-line arrangement, the handlebar connector, the torque sensor, and the steering column connector are arranged so as to overlap each other as viewed in a front-rear direction of the bicycle.

A front-rear direction herein refers to a front-rear direction as viewed from a rider operating the bicycle with the bicycle stem mounted on the bicycle.

A left-right direction herein refers to a left-right direction as viewed from a rider operating the bicycle with the bicycle stem mounted on the bicycle.

An up-down direction herein refers to an up-down direction as viewed from a rider operating the bicycle with the bicycle stem mounted on the bicycle.

According to example embodiments of the present invention, stems in each of which a torque sensor is compactly provided so as to have directionality in a measuring direction by utilizing the shapes and functions of the stems are provided.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a plan view showing a schematic configuration of a bicycle stem according to a first example embodiment of the present invention.

FIG. 2 is a left side view showing a schematic configuration of the bicycle stem.

FIG. 3 is a rear view showing a schematic configuration of the bicycle stem.

FIG. 4 is a left side view showing an example of arrangement of a steering assist motor.

FIG. 5 is a left side view showing a schematic configuration of a bicycle.

FIG. 6 is a left side view showing a schematic configuration of a bicycle stem according to a third example embodiment of the present invention.

FIG. 7 is a plan view showing a schematic configuration of the bicycle stem according to the third example embodiment of the present invention.

FIG. 8 is a cross-sectional view taken along line VIII-VIII in FIG. 7.

FIG. 9 is a left side view showing an example of arrangement of a torque sensor in a bicycle stem according to another example embodiment of the present invention.

FIG. 10 is a view showing an example of arrangement of a torque sensor in a bicycle stem according to another example embodiment of the present invention.

### DETAILED DESCRIPTION OF THE EXAMPLE EMBODIMENTS

Example embodiments will be described hereinafter with reference to the drawings. In the drawings, the same or corresponding elements, components, features, characteristics, etc., are denoted by the same reference numerals, and descriptions thereof will not be repeated. The dimensions of elements, components, features, characteristics, etc., in the drawings do not strictly represent actual dimensions of the elements, components, features, characteristics, etc., and dimensional proportions of the elements, components, features, characteristics, etc.

Hereinafter, arrow F in the drawings represents a forward direction of a vehicle. Arrow RR in the drawings represents a rearward direction of the vehicle. Arrow U in the drawings represents an upward direction of the vehicle. Arrow D in the drawings represents a downward direction of the vehicle. Arrow L in the drawings represents a leftward direction of the vehicle. Arrow R in the drawings represents a rightward direction of the vehicle. In the following description, the up-down direction, the left-right direction, and the front-rear direction respectively refer to an up-down direction, a left-right direction, and a front-rear direction as viewed from a rider operating the bicycle.

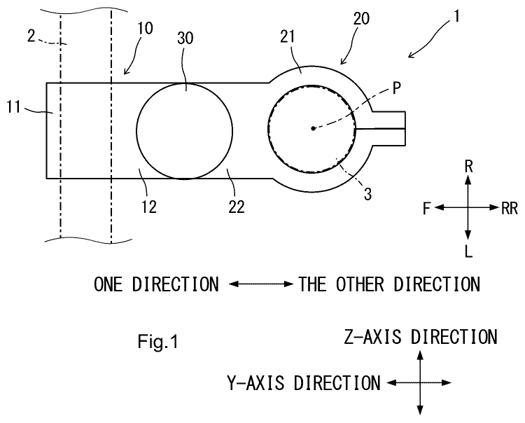

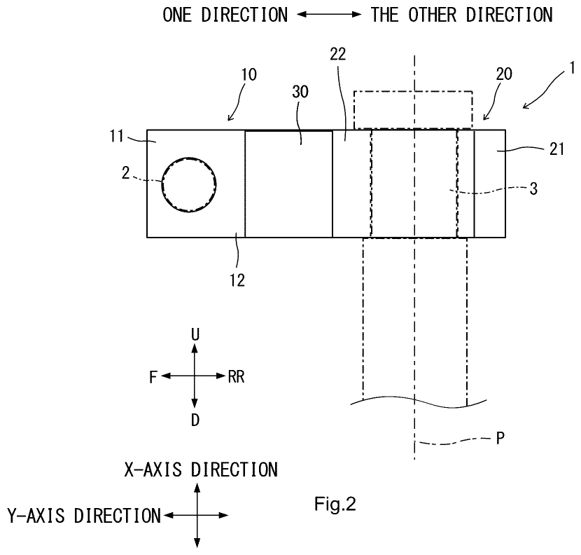

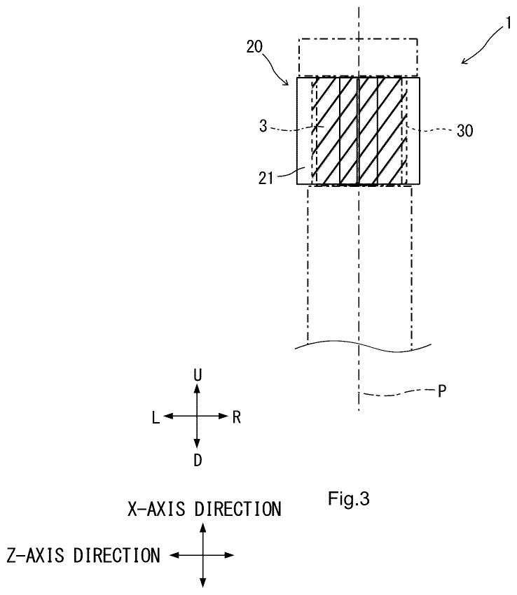

A bicycle stem 1 according to a first example embodiment of the present invention will be described with reference to FIGS. 1 to 3. FIG. 1 is a plan view showing a schematic configuration of the bicycle stem 1 according to the first example embodiment. FIG. 2 is a left side view showing a schematic configuration of the bicycle stem 1. FIG. 3 is a rear view showing a schematic configuration of the bicycle stem 1.

The bicycle stem 1 connects a handlebar 2 and a steering column 3 of a bicycle. As shown in FIGS. 1 and 2, the bicycle stem 1 includes a first stem 10 including a handlebar connector 11 connected to the handlebar 2, and a second stem 20 including a steering column connector 21 connected to the steering column 3.

More specifically, the bicycle stem 1 includes the first stem 10, the second stem 20, and a torque sensor 30. The first stem 10 includes the handlebar connector 11. The second stem 20 includes the steering column connector 21.

The first stem 10 and the second stem 20 are respectively connected to the torque sensor 30. The torque sensor 30 is a sensor to detect a torque applied to the handlebar 2 or the steering column 3. The torque detected by the torque sensor 30 is used, for example, for drive control of an unillustrated motor to apply a steering assist force to the steering column 3.

The torque sensor 30 is configured to accurately detect a torque applied about an X axis. That is, the torque sensor 30 is configured to, when an identical torque is applied respectively about mutually orthogonal X, Y, and Zaxes, be more deformable by the torque about the X axis than by the torque about the Y axis or the torque about the Z axis to detect the torque about the X axis when a force is input to the bicycle stem 1 from the handlebar 2 or the steering column 3. In the present example embodiment, the X axis is parallel to an axis of the steering column 3. The Y axis and the Z axis are respectively orthogonal to the X axis.

The first stem 10 is a rod-shaped structure. The first stem 10 includes, at an end portion in one direction, the handlebar connector 11 connected to the handlebar 2. The handlebar connector 11 includes, for example, a clamp structure. The first stem 10 includes, at an end portion in the other direction, a first torque sensor connector 12 connected to the torque sensor 30.

The handlebar connector 11 may include a structure other than a clamp structure as long as the handlebar connector 11 is connectable to the handlebar 2. The first torque sensor connector 12 may have a detachable structure, such as bolts or other fasteners, or fittings, or may have a non-detachable structure, such as joining or bonding. The first torque sensor connector 12 may be connected to a housing of the torque sensor 30. In this case, the torque sensor 30 can detect rotation about the X axis by relative rotation, with respect to the housing, of a portion of the torque sensor 30 to which a second torque sensor connector 22 is connected.

The second stem 20 is a rod-shaped structure. The second stem 20 includes, at an end portion in the other direction, the steering column connector 21 connected to the steering column 3. The steering column connector 21 includes, for example, a clamp structure. The second stem 20 includes, at an end portion in the one direction, the second torque sensor connector 22 connected to the torque sensor 30.

The second stem 20 is configured such that, as viewed in an axial direction of the steering column 3, the torque sensor 30 and the first stem 10 are spaced apart from the steering column 3 in a radial direction. Accordingly, the handlebar 2 connected to the handlebar connector 11 of the first stem 10 is also spaced apart from the steering column 3 in the radial direction, as viewed in the axial direction of the steering column 3. In the present example embodiment, the first stem 10 is spaced apart from the second stem 20 in the front-rear direction.

The steering column connector 21 may include a structure other than a clamp structure as long as the steering column connector 21 is connectable to the steering column 3. The second torque sensor connector 22 may include a detachable structure, such as bolts or other fasteners, or fittings, or may have a non-detachable structure, such as joining or bonding. The second torque sensor connector 22 may be connected to the housing of the torque sensor 30. In this case, the torque sensor 30 can detect rotation about the X axis by relative rotation, with respect to the housing, of a portion of the torque sensor 30 to which the first torque sensor connector 12 is connected.

The first stem 10 and the second stem 20 are configured such that the handlebar connector 11 is positioned farther forward than the steering column 3 and such that, when an identical torque about the X axis is applied, the first stem 10 and the second stem 20 are less deformable than the torque sensor 30. That is, when an identical torque about the X axis is applied to the first stem 10, the second stem 20, and the torque sensor 30, the torque sensor 30 is more deformable than the first stem 10 and the second stem 20.

As described above, the bicycle stem 1 of the present example embodiment is a so-called ahead stem that is connected to an outer peripheral surface of the steering column 3 in a direction intersecting an axis P thereof.

With at least one of the first stem 10 or the second stem 20 including a detachable connection structure with respect to the torque sensor 30, at least one of the first stem 10 or the second stem 20 can be replaced, thus allowing at least one of a position in the front-rear direction or a position in the up-down direction of the handlebar 2 with respect to the steering column 3 to be changed. Accordingly, at least one of the position in the front-rear direction or the position in the up-down direction of the handlebar 2 with respect to the steering column 3 can be readily changed. Therefore, while the torque sensor 30 is provided in the bicycle stem 1, the function of the stem to adjust the position of the handlebar 2 with respect to the steering column 3 can be maintained.

The first stem 10, the torque sensor 30, and the second stem 20 are arranged in a straight line as the bicycle stem 1 is viewed from above. That is, as shown in FIG. 3, the first stem 10, the torque sensor 30, and the second stem 20 overlap each other as the bicycle stem 1 is viewed in the front-rear direction. In FIG. 3, the torque sensor 30 is hatched for explanatory purposes. As the bicycle stem 1 is viewed in the front-rear direction, the torque sensor 30 overlaps at least a portion of the steering column connector 21. Accordingly, the torque sensor 30 can be compactly disposed in the left-right direction with respect to the bicycle stem 1.

The bicycle stem 1 according to the present example embodiment includes the torque sensor 30. The torque sensor 30 is configured to, when an identical torque is applied respectively about the mutually orthogonal X, Y, and Z axes, be more deformable by the torque about the X axis than by the torque about the Y axis or the torque about the Z axis to thus detect the torque about the X axis when a force is input from the handlebar 2 or the steering column 3. The bicycle stem 1 includes the first stem 10 including the handlebar connector 11 connected to the handlebar 2 and the first torque sensor connector 12 connected to the torque sensor 30, and the second stem 20 including the steering column connector 21 connected to the steering column 3 and the second torque sensor connector 22 connected to the torque sensor 30. The first stem 10 and the second stem 20 are configured such that the handlebar connector 11 is positioned farther forward than the steering column 3 and such that, when an identical torque about the X axis is applied, the first stem 10 and the second stem 20 are less deformable than the torque sensor 30.

As described above, the stem is separated into two stems including the first stem 10 and the second stem 20, and the torque sensor 30 is provided between the first stem 10 and the second stem 20. Accordingly, when an identical torque about the X axis is applied to the first stem 10 and the second stem 20 that are respectively connected to the torque sensor 30, the torque sensor 30 is more deformable than the first stem 10 and the second stem 20. Therefore, a signal-to-noise ratio (S/N ratio) of a torque signal detected by the torque sensor 30 can be increased. As a result, torque detection accuracy of the torque sensor 30 can be improved.

Moreover, the torque sensor 30 is connected to each of the first stem 10 and the second stem 20 and defines a portion of the bicycle stem. Accordingly, the torque sensor 30 is positioned relative to the first stem 10 connected to the handlebar 2 and the second stem 20 connected to the steering column 3. With this configuration, as compared with a configuration in which a plurality of sensors are provided, variation in the mounting position of the sensor is reduced. As a result, torque detection accuracy can be improved.

Therefore, it is possible to realize the bicycle stem 1 capable of improving torque detection accuracy of the torque sensor 30 while utilizing the functions of the stem.

The first stem 10 and the second stem 20 are configured such that, as viewed in the axial direction of the steering column 3, the handlebar connector 11, the first torque sensor connector 12, the steering column connector 21, and the second torque sensor connector 22 are arranged in the front-rear direction.

In such a configuration, the torque sensor 30 is provided between the first torque sensor connector 12 of the first stem 10 and the second torque sensor connector 22 of the second stem 20. The handlebar connector 11 of the first stem 10 and the steering column connector 21 of the second stem 20 are positioned radially outward with respect to the steering column 3 as viewed in the axial direction of the steering column 3. With the torque sensor 30 disposed relative to the first stem 10 and the second stem 20 in this manner, a torque applied to the handlebar 2 or the steering column 3 can be detected.

With the above-described configuration, as viewed in the axial direction of the steering column 3, the handlebar connector 11, the first torque sensor connector 12, the second torque sensor connector 22, and the steering column connector 21 are arranged in the front-rear direction. Thus, the torque sensor 30 can be compactly disposed in the left-right direction with respect to the bicycle stem 1.

Therefore, the torque sensor 30 can be compactly disposed on the bicycle stem 1 by utilizing the configuration and functions of the bicycle stem 1.

In the present example embodiment, the first torque sensor connector 12 of the first stem 10 or the second torque sensor connector 22 of the second stem 20 may be connected to the housing of the torque sensor 30.

Thus, a torque applied to the first stem 10 or the second stem 20 can be accurately detected by the torque sensor 30 by connecting the first stem 10 or the second stem 20 to the torque sensor 30.

In the present example embodiment, the first torque sensor connector 12 of the first stem 10 or the second torque sensor connector 22 of the second stem 20 may be integral (e.g., integrally formed or unitary) with at least a portion of the housing of the torque sensor 30.

Thus, a torque applied to the first stem 10 or the second stem 20 can be accurately detected by the torque sensor 30 by connecting the first stem 10 or the second stem 20 to the torque sensor 30.

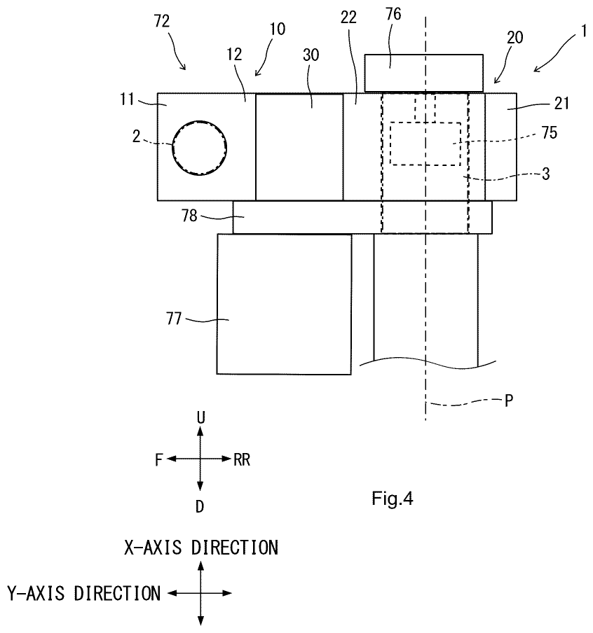

FIG. 4 is a left side view showing an example of arrangement of a steering assist motor 77 that applies a steering assist force to the steering column 3 to which the bicycle stem 1 is connected. As shown in FIG. 4, the steering assist motor 77 is connected to the steering column 3 via a torque transmission mechanism 78 so as to transmit a torque to the steering column 3.

The steering assist motor 77 is driven by an unillustrated control device based on a torque detected by the torque sensor 30. The torque output from the steering assist motor 77 is transmitted to the steering column 3 via the torque transmission mechanism 78. The steering assist motor 77 is positioned farther forward than the steering column 3. Although not specifically shown, the steering assist motor 77 is supported by a body frame of the bicycle.

The steering assist motor 77 is disposed forward of the steering column 3. The steering assist motor 77 may be disposed at any position relative to the steering column 3 as long as the steering assist motor 77 is disposed near the steering column 3, such as behind, to the left of, or to the right of the steering column 3. Although not specifically shown, the steering assist motor 77 is supported by the body frame of the bicycle.

The torque transmission mechanism 78 is connected to the steering assist motor 77 and the steering column 3 so as to transmit a torque output from the steering assist motor 77 to the steering column 3. The torque transmission mechanism 78 may have any configuration as long as the torque from the steering assist motor 77 can be transmitted to the steering column 3, such as gears, pulleys, links, belts, chains, and sprockets.

In FIG. 4, reference numeral 72 denotes a stem mechanism. The stem mechanism 72 includes the bicycle stem 1, an anchor 75, and a top cap 76.

The anchor 75 is disposed inside an upper portion of the steering column 3. A lower portion of the top cap 76 is rotatably connected to an upper portion of the anchor 75. The anchor 75 is configured to expand in the radial direction via an unillustrated tool so as to press against an inner peripheral surface of the steering column 3. The steering column 3 can be pulled up in the axial direction with respect to the unillustrated body frame of the bicycle by the anchor 75. The anchor 75 corresponds to a lifter.

The torque sensor 30 overlaps at least a portion of the anchor 75 as the bicycle stem 1 is viewed in the front-rear direction.

Accordingly, the torque sensor 30 is disposed in the vicinity of the upper portion of the steering column 3 such that it overlaps at least a portion of the anchor 75 as the bicycle stem 1 is viewed in the left-right direction or the front-rear direction. That is, large upward protrusion of the torque sensor 30 relative to the upper portion of the steering column 3 can be prevented. This enables the torque sensor 30 to be compactly disposed with respect to the steering column 3 in the up-down direction.

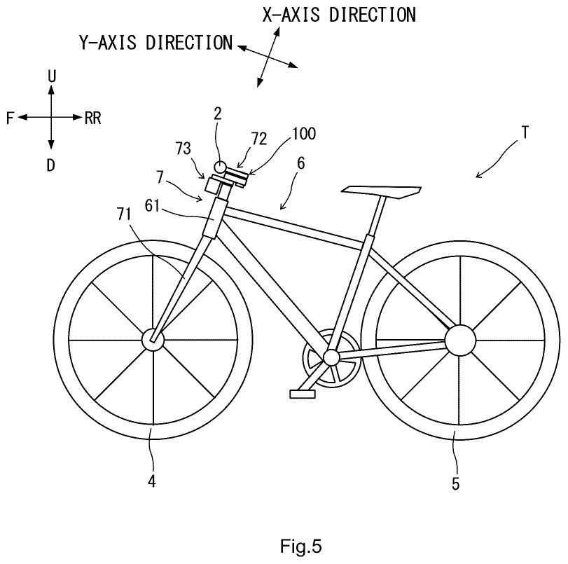

FIG. 5 is a left side view showing a schematic configuration of a bicycle T including a bicycle stem 100. The bicycle T according to the present example embodiment is, for example, a two-wheeled vehicle. The bicycle T includes a front wheel 4, a rear wheel 5, a body frame 6, and a steering mechanism 7. Since respective configurations of the front wheel 4, the rear wheel 5, and the body frame 6 are the same as those of a conventional bicycle, detailed descriptions thereof are omitted. Components having the same configurations as those of the first and second example embodiments are denoted by the same reference numerals, and descriptions thereof are omitted.

The steering mechanism 7 includes a fork portion 71, the steering column 3, the stem mechanism 72, a steering assist device 73, and the handlebar 2. The steering column 3 extends obliquely such that an upper end portion thereof is positioned farther rearward than a lower end portion thereof.

The fork portion 71 rotatably supports the front wheel 4 at a lower end thereof. The steering column 3 is connected to an upper end portion of the fork portion 71. The steering column 3 passes through a head tube 61 of the body frame 6. The stem mechanism 72 is mounted on the upper end portion of the steering column 3. The handlebar 2 is supported by the stem mechanism 72. The steering assist device 73 assists steering of the handlebar 2 based on torque applied to the handlebar 2 or the steering column 3.

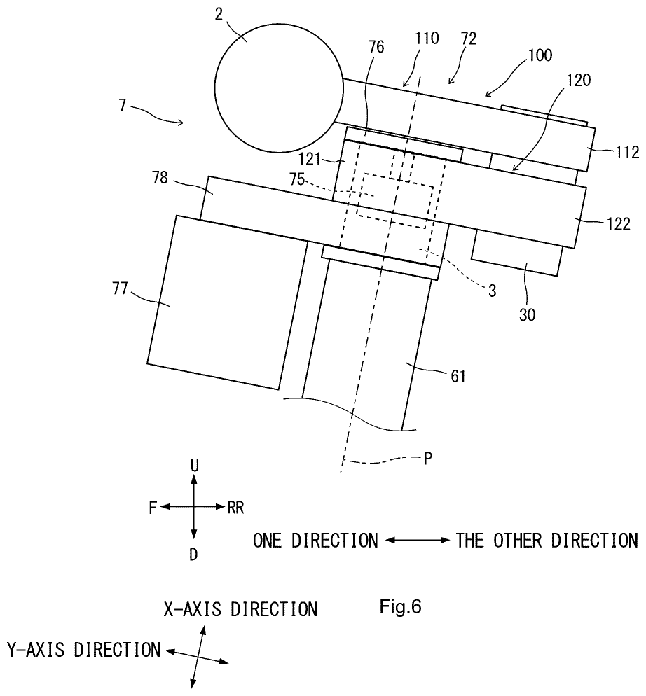

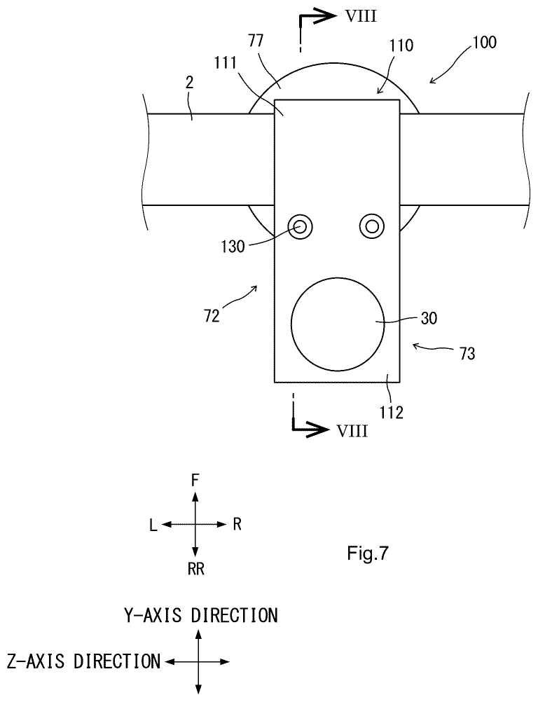

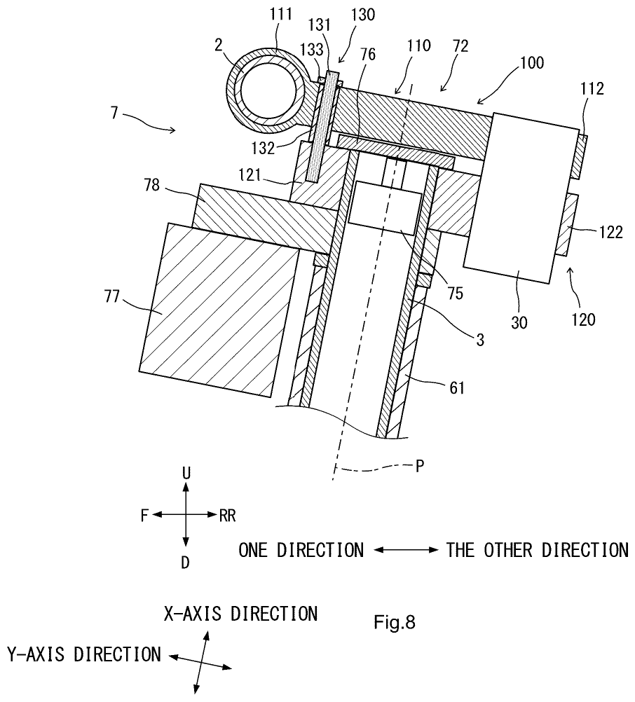

FIG. 6 is a left side view showing a schematic configuration of the stem mechanism 72 and the steering assist device 73. FIG. 7 is a plan view showing a schematic configuration of the stem mechanism 72 and the steering assist device 73. FIG. 8 is a cross-sectional view taken along line VIII-VIII in FIG. 7. The stem mechanism 72 includes the bicycle stem 100, the anchor 75, and the top cap 76.

The bicycle stem 100 includes a first stem 110, the torque sensor 30, a second stem 120, and a movement restrictor 130.

The first stem 110 includes, at an end portion in one direction, a handlebar connector 111. The handlebar 2 is connected to the handlebar connector 111. The first stem 110 includes, at an end portion in the other direction, a first torque sensor connector 112 connected to the torque sensor 30.

The second stem 120 includes, at an end portion in the one direction, a steering column connector 121. The steering column 3 is connected to the steering column connector 121. The second stem 120 includes, at an end portion in the other direction, a second torque sensor connector 122 connected to the torque sensor 30.

The torque sensor 30 is positioned farther rearward than the steering column 3. Accordingly, the second stem 120 is connected so as to extend rearward with respect to the steering column 3. The first stem 110 is positioned outward of the steering column 3 in the axial direction and extends in a direction intersecting the axis P of the steering column 3 as viewed in the left-right direction. The first stem 110 is spaced apart from the second stem 120 in the axial direction of the steering column 3, that is, in the X axis direction.

The movement restrictor 130 restricts relative movement between the first stem 110 and the second stem 120 in the X axis direction by an amount that is equal to or greater than a predetermined amount. The movement restrictor 130 also restricts relative rotation between the first stem 110 and the second stem 120 about the X axis by an angle that is equal to or greater than a predetermined angle.

Specifically, the movement restrictor 130 includes a restricting pin 131, a cylindrical elastic body 132, and a retainer 133. The restricting pin 131 passes through the first stem 110 in the X axis direction, with one end fixed to the second stem 120. The other end of the restricting pin 131 protrudes farther upward than the first stem 110. The elastic body 132 includes a material that is elastically deformable in a radial direction. The elastic body 132 covers a portion of the restricting pin 131 that extends through the first stem 110. That is, the restricting pin 131 and the elastic body 132 pass through the first stem 110 in the X axis direction.

The retainer 133 is attached to the other end of the restricting pin 131 that protrudes farther upward than the first stem 110. The retainer 133 may include a C-shaped structure attached to an unillustrated groove on an outer peripheral surface of the restricting pin 131 and that extends in the circumferential direction, or may include an annular structure fitted to the outer peripheral surface of the restricting pin 131.

With the above-described configuration, when relative movement between the first stem 110 and the second stem 120 in the X axis direction reaches or tends to exceed the predetermined amount, the relative movement between the first stem 110 and the second stem 120 is restricted by the retainer 133 attached to the other end of the restricting pin 131 of the movement restrictor 130. Accordingly, in this case, the movement restrictor 130 functions as an X axis direction movement restrictor. The predetermined amount is an amount of movement that reduces performance or measurement accuracy of the torque sensor 30 when relative movement between the first stem 110 and the second stem 120 in the X axis direction occurs.

With the above-described configuration, when relative rotation between the first stem 110 and the second stem 120 about the X axis reaches or tends to exceed the predetermined angle, the relative rotation between the first and second stems 110 and 120 is restricted by the restricting pin 131 of the movement restrictor 130. Accordingly, in this case, the movement restrictor 130 functions as an X axis rotation restrictor. The predetermined angle is an amount of movement that reduces performance or measurement accuracy of the torque sensor 30 when relative rotation between the first stem 110 and the second stem 120 about the X axis occurs.

The steering assist device 73 includes the torque sensor 30, the steering assist motor 77, and the torque transmission mechanism 78.

The torque sensor 30 overlaps at least a portion of the anchor 75 as the bicycle stem 100 is viewed in the front-rear direction.

Accordingly, the torque sensor 30 is disposed in the vicinity of the steering column 3 such that it overlaps at least a portion of the anchor 75 as the bicycle stem 100 is viewed in the left-right direction or the front-rear direction. That is, large upward protrusion of the torque sensor 30 relative to the upper portion of the steering column 3 can be prevented. This enables the torque sensor 30 to be compactly disposed with respect to the steering column 3 in the up-down direction.

The first stem 110 is spaced apart from the second stem 120 in the X axis direction. Accordingly, relative displacement between the first stem 110 and the second stem 120 more readily occurs due to a torque applied about the X axis. Therefore, the torque applied to the first stem 110 and the second stem 120 can be more readily detected by the torque sensor 30.

Example embodiments of the present invention have been described above, but these example embodiments are merely examples of the present invention. Thus, the present invention is not limited to the example embodiments described above, and the example embodiments may be modified as necessary within a range not departing from the gist of the present invention.

In each of the example embodiments, the bicycle stems 1 and 100 are ahead stems. Alternatively, the bicycle stem may be a quill stem that is connected to the steering column by pressing a fixture provided at a lower end portion of the stem against an inner surface of an upper portion of the steering column.

In each of the example embodiments, the X axis is parallel to the axis P of the steering column. Alternatively, the X axis may extend in the up-down direction, the front-rear direction, or the left-right direction. This enables various torques applied to the handlebar or the steering column to be detected by the torque sensor configured to readily detect a torque about the X axis. Thus, by disposing the torque sensor with respect to the stem in accordance with a use condition of the bicycle, torque detection by the torque sensor can be performed in consideration of the use condition. Accordingly, an S/N ratio of a torque signal detected by the torque sensor can be increased, thus increasing torque detection accuracy of the torque sensor.

In each of the example embodiments, the torque sensor 30 is positioned in the front-rear direction with respect to the steering column connector 21 or 121. Alternatively, the torque sensor may be positioned in the left-right direction with respect to the steering column connector. In this case, the torque sensor may be disposed such that at least a portion of the torque sensor overlaps the steering column connector as the bicycle stem is viewed in the left-right direction.

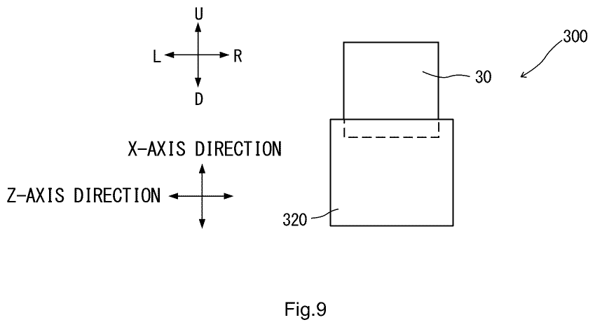

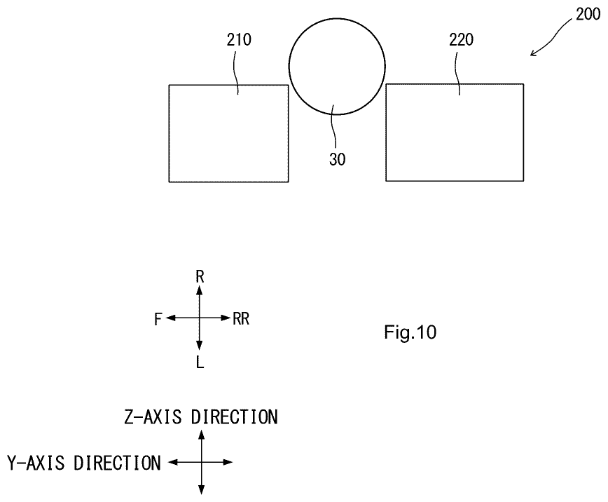

The torque sensor may be disposed such that a portion of the torque sensor overlaps the second stem as the bicycle stem is viewed in the front-rear direction. FIGS. 9 and 10 are views schematically showing a state in which a portion of the torque sensor 30 overlaps the second stem 220 and 320 as the bicycle stems 200 and 300 are viewed in the front-rear direction. The entirety of the torque sensor 30 does not need to overlap the second stem 220 or 320 as the bicycle stems 200 and 300 are viewed in the front-rear direction. In FIG. 10, reference numeral 210 denotes a first stem.

In the first and second example embodiments, each of the bicycle stems 1 and 100 includes the second stem 20 or 120, the torque sensor 30, and the first stem 10 or 110 arranged in this order from the steering column 3 toward the handlebar 2 in a plan view. Alternatively, the second stem, the torque sensor, and the first stem may be arranged in any order as long as the torque sensor is positioned between the second stem and the first stem.

In the first and second example embodiments, the torque sensor 30 is positioned farther forward than the steering column 3. Alternatively, the torque sensor may be positioned farther rearward than the steering column or may be positioned leftward or rightward relative to the steering column.

In the first and second example embodiments, the steering column 3 extends in the up-down direction. Alternatively, as in the third example embodiment, the steering column may extend obliquely. The steering column in the third example embodiment may also extend in the up-down direction, as in the first and second example embodiments.

In the third example embodiment, the torque sensor 30 overlaps at least a portion of the anchor 75 as the bicycle stem 100 is viewed in the front-rear direction. Alternatively, the torque sensor may overlap at least a portion of the anchor as the bicycle stem is viewed in the left-right direction.

In the third example embodiment, the steering assist motor 77 is positioned farther forward than the steering column 3. Alternatively, the steering assist motor may be disposed at any position relative to the steering column as long as the steering assist motor is disposed near the steering column, such as behind, to the left of, or to the right of the steering column.

In the third example embodiment, the bicycle stem 100 includes the movement restrictor 130. Alternatively, the bicycle stem may be free of the movement restrictor. The movement restrictor may function as the X axis rotation restrictor, without functioning as the X axis direction movement restrictor. The movement restrictor may function as the X axis direction movement restrictor, without functioning as the X axis rotation restrictor. The movement restrictor may have any configuration other than that illustrated in the third example embodiment as long as it can function as at least one of the X axis direction movement restrictor or the X axis rotation restrictor.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A bicycle stem comprising:
a torque sensor that is more deformable by a torque about an X axis than by a torque about a Y axis or a torque about a Z axis when an identical torque is applied respectively about the X, Y, and Z axes, which are mutually orthogonal, to detect the torque about the X axis when a force is input from a handlebar or a steering column;
a first stem including a handlebar connector connected to the handlebar and a first torque sensor connector connected to the torque sensor; and
a second stem including a steering column connector connected to the steering column and a second torque sensor connector connected to the torque sensor; wherein
the first stem and the second stem are configured such that the handlebar connector is positioned farther forward than the steering column and such that, when an identical torque about the X axis is applied, the first stem and the second stem are less deformable than the torque sensor.

2. The bicycle stem according to claim 1, wherein the X axis extends in a left-right direction, an up-down direction, or a front-rear direction.

3. The bicycle stem according to claim 1, wherein the first stem is spaced apart from the second stem in an X axis direction.

4. The bicycle stem according to claim 1, further comprising an X axis direction movement restrictor positioned between the first stem and the second stem to restrict relative movement between the first stem and the second stem in an X axis direction by an amount that is equal to or greater than a predetermined amount.

5. The bicycle stem according to claim 1, further comprising an X axis rotation restrictor positioned between the first stem and the second stem to restrict relative rotation between the first stem and the second stem about the X axis by an angle that is equal to or greater than a predetermined angle.

6. The bicycle stem according to claim 1, wherein the first stem and the second stem are configured such that, as viewed in an axial direction of the steering column, the handlebar connector, the first torque sensor connector, the second torque sensor connector, and the steering column connector are arranged in a front-rear direction.

7. The bicycle stem according to claim 1, wherein the first torque sensor connector of the first stem or the second torque sensor connector of the second stem is connected to a housing of the torque sensor.

8. The bicycle stem according to claim 1, wherein the first torque sensor connector of the first stem or the second torque sensor connector of the second stem is integral with at least a portion of a housing of the torque sensor.

9. A bicycle comprising:
the bicycle stem according to claim 1.
